(19) United States
(12) Patent Application Publication
(10) Pub. No.: US 2014/0248531 A1
(43) Pub. Date: Sep. 4, 2014

(54) NEGATIVE ELECTRODE ACTIVE MATERIAL FOR ENERGY STORAGE DEVICES AND METHOD FOR MAKING THE SAME

(71) Applicant: IMRA AMERICA, INC, Ann Arbor, MI (US)

(72) Inventors: Bing TAN, Ann Arbor, MI (US); Zhendong HU, Ann Arbor, MI (US); Guanghui HE, Ann Arbor, MI (US); Yong CHE, Ann Arbor, MI (US)

(73) Assignee: IMRA AMERICA, INC., Ann Arbor, MI (US)

(21) Appl. No.: 14/178,428

(22) Filed: Feb. 12, 2014

Related U.S. Application Data
(60) Provisional application No. 61/771,346, filed on Mar. 1, 2013.

(51) Int. Cl. H01M 4/485; H01M 4/36; H01G 11/06; C01G 23/053; H01M 4/04; H01M 4/1391; H01M 10/0525; H01M 4/62

(52) U.S. Cl. CPC H01M 4/485; H01M 10/0525; H01M 4/366; H01M 4/625; C01G 23/053; H01M 4/0471; H01M 4/1391; C01G 23/0536; H01G 11/06
USPC 429/188; 252/182.1; 252/507; 429/231.5; 361/525

(57) ABSTRACT

The described embodiments provide an energy storage device that includes a positive electrode including a material that stores and releases ion, a negative electrode including Nb-doped TiO₂(B), and a non-aqueous electrolyte containing lithium ions. The described embodiments provide a method including the steps of combining at least one titanium compound and at least one niobium compound in ethylene glycol to form a precursor solution, adding water into the precursor solution to induce hydrolysis and condensation reactions, thereby forming a reaction solution, heating the reaction solution to form crystallized particles, collecting the particles, drying the collected particles, and applying a thermal treatment at a temperature >350° C. to the dried particles to obtain Nb-doped TiO₂(B) particles.

### BACKGROUND

1. Field of the Invention

The present invention relates to lithium-based energy storage devices generally, and, in particular, to negative electrode active materials for lithium-based energy storage devices.

2. Description of the Related Art

In conventional lithium ion batteries, negative electrode active materials are based on graphite, which generally has lithium intercalation potential at about 0.1V (relative to a reference Li/Li⁺ redox potential). Lithium may be deposited onto an electrode from an electrolyte at a high charge rate because of over-shooting of the potential, which is expected because of an increased internal voltage drop with an increased charge rate. The deposition of the lithium may cause serious safety issues including burning of the battery. In addition to the potential voltage over-shooting issue, a graphite negative electrode may also have issues resulted from a solid electrolyte interface (SEI) layer, which is generated from decomposition of an organic electrolyte and a lithium salt at a voltage <0.8V (relative to Li/Li⁺). The formation and dissolution of the SEI layer may generate heat and the SEI layer may retard the lithium insertion/extraction rate during a charge/discharge process.

In comparison, Li₄Ti₅O₁₂ (LTO) has a lithium intercalation/de-intercalation potential about 1.45V/1.65V (relative to a reference Li/Li⁺ potential) with good reversibility and structural stability during the charge/discharge process. Because of the high intercalation potential, lithium is not likely to be deposited during the charge process and the formation of the SEI layer might also be avoided because of the high lithium intercalation/de-intercalation potential. Moreover, the volume change of Li₄Ti₅O₁₂ during the charge/discharge process is nearly zero, which results in a good cycling stability. Although Li₄Ti₅O₁₂ has been used as a negative electrode material with high rate capability, wide operating temperature, and long cycle life, the theoretical specific capacity of Li₄Ti₅O₁₂ is only about 175 mAh/g. This limits energy density of a lithium ion battery based on Li₄Ti₅O₁₂ because only half of the titanium may be electrochemically-active in a spinel crystal structure.

On the other hand, TiO₂ with an anatase crystal structure (TiO₂ (anatase)) has a theoretical specific capacity of 335 mAh/g. The lithium intercalation/de-intercalation potential for this material, however, is about 1.78V/1.91V vs. Li/Li⁺, which is much higher than the potential for Li₄Ti₅O₁₂. It is desirable if another material with similar theoretical capacity to TiO₂ (anatase), but with lower intercalation/de-intercalation potential could be developed.

An alternative negative electrode material, TiO₂(B), has a theoretical specific capacity of about 335 mAh/g and a lithium intercalation/de-intercalation potential at about 1.55V/1.65V vs. Li/Li⁺, which is more attractive than Li₄Ti₅O₁₂ for its capacity (e.g., 335 mAh/g for TiO₂(B) vs. 175 mAh/g for Li₄Ti₅O₁₂) and more attractive than TiO₂ (anatase) for its relatively low de-intercalation potential (e.g., about 1.65V for TiO₂(B) vs. 1.91V for TiO₂ (anatase)).

It is known that there are seven known polymorphs of TiO₂, six of which, rutile, anatase, brookite, TiO₂(B), TiO₂ II, and TiO₂(H), have distinct structures. TiO₂(B) is found as a mineral in magmatic rocks and hydrothermal veins, as well as weathering rims on perovskite. TiO₂(B) also forms lamellae in other minerals.

TiO₂(B) is generally produced by one of two techniques. In one technique, TiO₂(B) is produced by an ion exchange process. In this case, hydrogen titanate is made first by replacing sodium or potassium ions in sodium or potassium titanate with proton ions. TiO₂(B) is then obtained after heating the hydrogen titanate at a temperature ranging from 400° C. to 600° C. This technique is tedious because of the ion-exchange process, which may take several days. A second technique (i.e., solvothermal process) produces TiO₂(B) in one step without the ion-exchange process. In this case, a titanium-glycolate complex is thermally hydrolyzed and condensed in a solution to generate TiO₂(B) particles directly. The produced sample is then heated at a mild temperature (e.g., 250° C. to 350° C.) to remove the organic impurities in a post-treatment step. The heated sample shows high capacity and relatively good cycling stability. Its columbic efficiency for the 1^{st} cycle, however, is only about 75% (e.g., Liu et al., “Nanosheet-Constructed Porous TiO₂—B for Advanced Lithium Ion Batteries”, Advanced Materials, vol. 24, (May 18, 2012), pp. 3201-3204), which means that about 25% capacity is not recovered during the 1^{st} cycle. For an energy storage device, it is desirable to have higher columbic efficiency (e.g., >75%) during the 1^{st} charge/discharge cycle. An increase of the heating temperature during the post-treatment step may be beneficial to increase the columbic efficiency during the 1^{st} cycle. The increase of the heating temperature, however, may change the crystal structure of the obtained sample, which is not desirable. For example, the TiO₂(B) crystal structure will transform into an anatase crystal structure when the sample is heated at 450° C. in air for a few hours (e.g., 2 hours). The instability of TiO₂(B) obtained from the solvothermal process at a relatively high temperature (e.g., 450° C. and above) may limit its applications. For example, it will be difficult to apply a carbon coating onto these TiO₂(B) particles by using a wet chemistry process since a heating temperature as high as 450° C. and above generally is needed to decompose organics into carbon. It is therefore desirable to make TiO₂(B) that can maintain its TiO₂(B) crystal structure at a relatively high temperature (e.g., >350° C.).

### SUMMARY

The described embodiments provide a negative electrode active material for energy storage devices comprising Nb-doped TiO₂(B).

The described embodiments provide an energy storage device that includes a positive electrode including a material that stores and releases ion, a negative electrode including Nb-doped TiO₂(B), and a non-aqueous electrolyte containing lithium.

The described embodiments provide a method including the steps of combining at least one titanium compound and at least one niobium compound in ethylene glycol to form a precursor solution, adding water into the precursor solution to induce hydrolysis and condensation reactions, thereby forming a reaction solution, heating the reaction solution to form solid particles, collecting the particles, drying the collected particles, and applying a thermal treatment at a temperature >350° C. to the dried particles to form Nb-doped TiO₂(B) particles.

### BRIEF DESCRIPTION OF THE DRAWING FIGURES

Other aspects, features, and advantages of described embodiments will become more fully apparent from the following detailed description, the appended claims, and the accompanying drawings in which like reference numerals identify similar or identical elements.

FIG. 1 is a sectional view schematically showing an energy storage device in accordance with exemplary embodiments of the present invention;

FIG. 2 is a sectional view schematically showing a structure of a portion of the energy storage device of FIG. 1 having a Nb-doped TiO₂(B) negative electrode;

FIG. 3 shows XRD patterns for TiO₂ heated at (a) 110° C., (b) 350° C., and (c) 450° C. in accordance with exemplary embodiments of the present invention;

FIG. 4A shows representative constant current charge curves for samples TiO₂-1-350C and TiO₂-1-450C in accordance with exemplary embodiments of the present invention;

FIG. 4B shows representative constant current discharge curves for samples TiO₂-1-350C and TiO₂-1-450C in accordance with exemplary embodiments of the present invention;

FIG. 5 shows XRD patterns for samples (a) TiO₂-2-450C and (b) Nb_{0.1}Ti_{0.9}O₂-2-450C in accordance with exemplary embodiments of the present invention;

FIG. 6A shows representative constant current charge curves for samples TiO₂-2-450C and Nb_{0.1}Ti_{0.9}O₂-2-450C in accordance with exemplary embodiments of the present invention;

FIG. 6B shows representative constant current discharge curves for samples TiO₂-2-450C and Nb_{0.1}Ti_{0.9}O₂-2-450C in accordance with exemplary embodiments of the present invention;

FIG. 7 shows XRD patterns for samples (a) Nb₁Ti₁₉-450C, (b) Nb₁Ti₉-450C, (c) Nb₁Ti₃-450C, (d) Nb₁Ti₁-450C, and (e) Nb₁Ti₀-450C in accordance with exemplary embodiments of the present invention;

FIG. 8 shows XRD patterns for samples (a) Nb₁Ti₉-550C, (b) Nb₁Ti₃-550C, (c) Nb₁Ti₁-550C, and (d) Nb₁Ti₀-550C in accordance with exemplary embodiments of the present invention;

FIG. 9 shows XRD patterns for samples (a) Nb₁Ti₉-650C, (b) Nb₁Ti₃-650C, and (c) Nb₁Ti₁-650C in accordance with exemplary embodiments of the present invention; and

FIG. 10 shows constant current charge/discharge curves for samples Nb₁Ti₃-650C at the 1^{st} cycle in accordance with exemplary embodiments of the present invention.

### DETAILED DESCRIPTION

Described embodiments relate to compositions of a Nb-doped TiO₂(B) based negative electrode active material for energy storage devices and a method to make the same.

Hereinafter, exemplary embodiments are described with reference to the drawing figures.

### Energy Storage Devices

The energy storage devices in the described embodiments include lithium ion capacitors and lithium ion batteries.

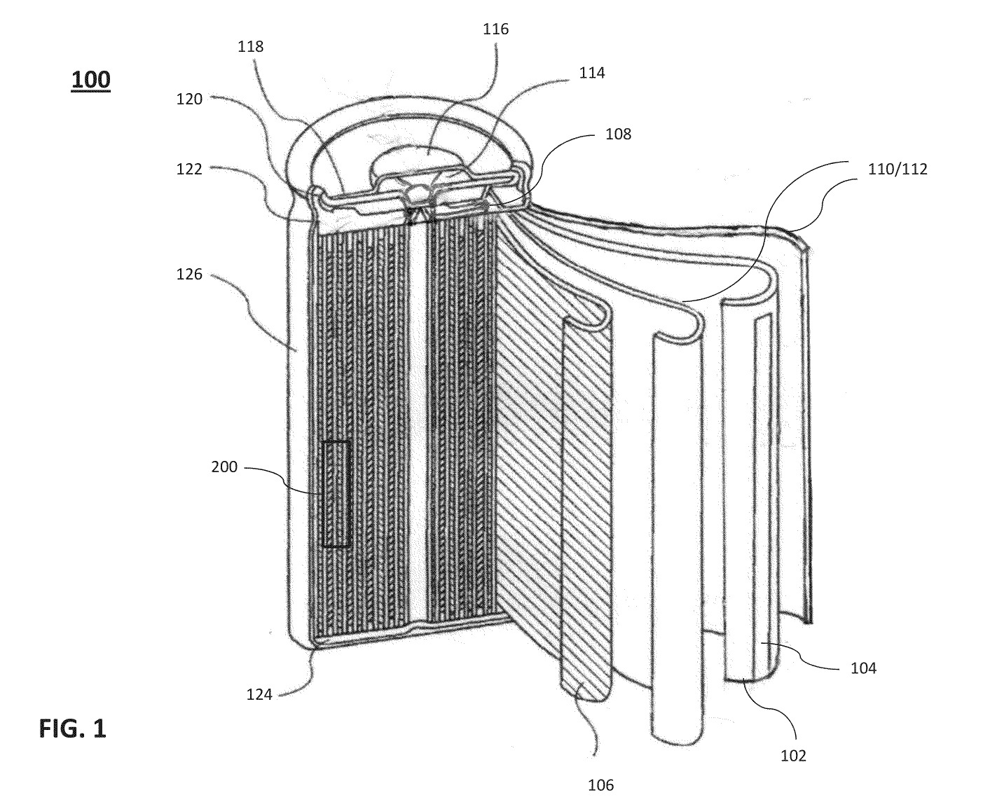

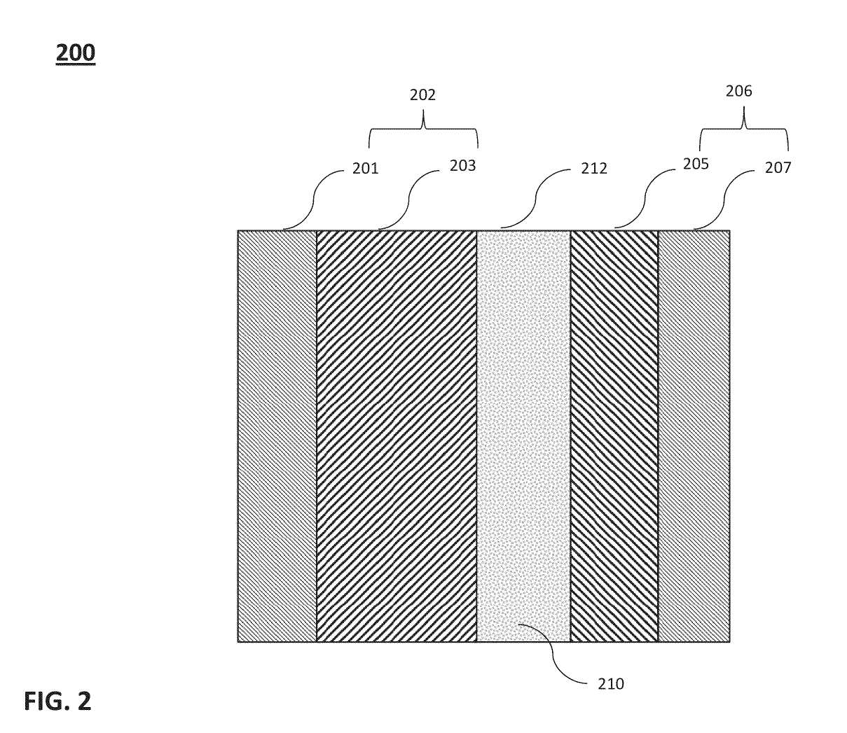

Referring to FIG. 1, exemplary energy storage device 100 includes negative electrode 102, negative lead tab 104, positive electrode 106, positive lead tab 108, electrolyte 110, separator 112, safety vent 114, positive electrode cap 116, positive temperature coefficient (PTC) device 118, gasket 120, insulators 122 and 124, and battery housing 126. Although the energy storage device is illustrated as cylindrical structure, any other shape, such as prismatic, aluminum pouch, or coin type may be used. Numeral 200 represents a minimum functional unit including a layer of negative electrode, a layer of positive electrode, and a layer of separator between the negative and positive electrodes. Energy storage device 100 is formed by stacking or winding together several minimum functional units 200 to obtain the desired voltage/current characteristic of completed energy storage device 100. A sectional view of a minimum functional unit is illustrated in FIG. 2 in accordance with exemplary embodiments.

Referring to FIG. 2, minimum functional unit 200 of the energy storage device in FIG. 1 is shown in detail. Unit 200 includes negative electrode 202, positive electrode 206, electrolyte 210, and separator 212. Electrolyte 210 is included in separator 212 and contains a non-aqueous lithium salt, such as LiPF₆, LiBF₄, LiClO₄, and LiBOB (lithium bis(oxalato)borate).

Negative electrode 202 may be formed by applying negative electrode material 203 onto one or both surfaces of current collector 201 or made only of negative electrode active material 203.

Current collector 201 is an electrical conductive substrate made of stainless steel, copper, nickel, aluminum, iron, titanium, graphite, carbon black, carbon nanotubes, graphene, conductive polymer, or the like. Aluminum is preferred because of its good electrical conductivity, good chemical stability, and light weight. Current collector 201 may be a sheet, plate, foil, mesh, expanded mesh, felt, or foam shape.

Negative electrode material 203 may comprise negative electrode active material, electrically conductive additive, and polymer binder. Negative electrode active material may be a material capable of reversibly containing lithium ions. An electrically conductive additive such as carbon black improves the electrical conductivity of the layer of electrode material to facilitate the electron transport to and transport from the current collector to the particles of the negative electrode active material. Polymer binder may bind the particles of electrode active material and carbon black together to ensure the good electrical contacts among all particles and between the current collector and the electrode material layer. Both the electrically conductive additive and the polymer binder generally are not electrochemically-active during the cycling, so they are not electrode active materials in the electrode material 203. In one exemplary embodiment, negative electrode material 203 includes Nb—TiO₂(B). The Nb—TiO₂(B) is described in detail below in the section titled Negative Electrode Active Materials.

Positive electrode 206 includes current collector 205 and positive electrode material 207 and may be fabricated for high rate applications. Current collector 205 is preferably made from aluminum even if other electrically conductive substances can be used. Positive electrode 206 is formed by applying positive electrode material 207 onto one surface or both surfaces (not shown) of current collector 205 or is made only of positive electrode material 207. Here, positive electrode material 207 may include a positive electrode active material, an electrically conductive additive such as carbon black, and a polymer binder. The positive electrode active material may be any existing or prospective positive electrode material known in the art, such as a carbonaceous material with high specific surface area, and a metal oxide that may be inserted and extracted with lithium ions including LiFePO₄ and LiMn₂O₄.

### Positive Electrode Active Materials

Referring to FIG. 2, as described above, positive electrode material 207 includes positive electrode active material, electrically conductive additive, and polymer binder. Positive electrode active material may be a material capable of reversibly containing ions. An electrically conductive additive and polymer binder may improve the electrical conductivity of the electrode material layer and are generally not electrochemically-active during cycling.

The positive electrode active material may be a carbonaceous material with a high specific surface area that stores ions through an adsorption/de-sorption process. The carbonaceous material may be selected from, but not limited to the existing positive electrode materials for lithium ion capacitors. A lithium ion capacitor is an energy storage device that has a positive electrode active material storing electrons from an ion adsorption/de-sorption process, a negative electrode active material storing/releasing lithium ions through faradic reactions (e.g., lithium intercalation/de-intercalation), and an electrolyte containing lithium ions. The specific surface area is preferred to be greater than 100 m²/g, preferably between 1000 m²/g and 3500 m²/g. The positive electrode active material includes, but is not limited to activated carbon, carbon nanotubes, graphene, carbon black, carbon nanoparticles, and carbon nanocrystals.

The positive electrode active material may be a material that might store/release lithium ions through a lithium intercalation/de-intercalation process, which may be selected from, but not limited to the existing positive electrode materials for lithium ion batteries. A lithium ion battery generally includes a positive electrode active material that stores/releases lithium ions and a negative electrode active material that also stores/releases lithium ions. The positive electrode active material may be selected from, but not limited to LiFePO₄, LiMn₂O₄, LiMnO₂, LiNiO₂, LiCoO₂, LiM_{n0.5}N_{i0.5}O₂, LiN_{i0.5}Mn_{1.5}O₄, LiCO_{1/3}Ni_{1/3}Mn_{1/3}O₂, xLi₂MnO₃.(1-x)LiMO₂ (0≦x≦1; M: Mn, Co, Ni), LiV₃O₈, and LiVPO₄F. It may also include a non-lithiated material comprising FePO₄, V₂O₅, and MnO₂.

In one exemplary embodiment, the positive electrode active material includes sulfur, which stores lithium by forming lithium-sulfur species. A carbon-sulfur composite is generally used to ensure good electrical conductivity of the electrode film.

In an alternative exemplary embodiment, the positive electrode active material includes at least one air catalyst that may catalyze either the reduction process of oxygen, or the oxidation process of oxide, or both.

In another alternative exemplary embodiment, the positive electrode active material includes a metal fluoride that interacts with lithium ions through a conversion reaction.

### Separator

Referring to FIG. 2, as described above, separator 212 includes a porous membrane that electrically separates the negative electrode from the positive electrode, while permitting ions to flow across the separator. The separator may be made from a material selected from nonwoven fibers (e.g., nylon, cotton, polyesters, glass), polymer films (e.g., polyethylene (PE), polypropylene (PP), poly(tetrafluoroethylene) (PTFE), Polyvinylidene fluoride (PVDF), and poly(vinyl chloride) (PVC)), and naturally occurring substances (e.g., rubber, asbestos, wood, and sand).

### Electrolyte

Referring to FIG. 2, electrolyte 210 may be a non-aqueous lithium-ion salt solution which is combined with other organic components. The lithium-ion salt includes lithium hexafluoro phosphate (LiPF₆), lithium tetrafluoroborate (LiBF₄), lithium perchlorate (LiClO₄), and lithium bis(oxalato)borate (LiBOB), but is not limited thereto. In one exemplary embodiment, electrolyte 106 includes an organic solvent and a lithium ionic salt. The organic solvent dissolves the lithium ionic salt forming the lithium-ion salt solution that is stable against the reduction of lithiated TiO₂. Examples of suitable organic solvents may be hexane, tetrahydrofuran (THF), propylene carbonate (PC), ethylene carbonate (EC), diethyl carbonate (DEC), dimethyl carbonate (DMC), and acetonitrile (ACN), but are not limited thereto.

### Negative Electrode Active Materials

Referring to FIG. 2, as described above, negative electrode material 203 includes an Nb-doped TiO₂ based material having a TiO₂(B) crystal structure (i.e., Nb-doped TiO₂(B)). The Nb-doped TiO₂(B) based material maintains its TiO₂(B) crystal structure after heating at a temperature of >350° C. and may be stable up to 650° C.

In the described embodiments of the present invention, the Nb-doped TiO₂(B) is synthesized by a solvothermal process. The solvothermal process is described in detail below in the section titled Solvothermal Process.

TiO₂ particles collected from the solvothermal process have organic impurities considered to be from non-decomposed titanium-glycolate groups. These particles need to be heated at a mild high temperature (e.g., about 250° C. to 350° C.) to decompose the organic impurities and remove the water content. The obtained TiO₂(B) particles (e.g., sample TiO₂-1-350C discussed in Example 1) shows a large irreversible capacity loss (about 22%) during the 1^{st} charge/discharge cycle. In order to reduce the irreversible capacity loss during the 1st charge/discharge cycle, the heating temperature during the post-treatment step may need to be increased. The increase in the heating temperature also helps to decompose organic impurities generated from the synthesis more completely since organics may not be completely decomposed at 350° C. Organics generally need a heating temperature of about 400° C. and above to be completely decomposed. Besides reducing the irreversible capacity loss and decomposing the organic impurities, more options for other post-treatments such as carbon coating, may also need a temperature about 450° C. and higher. It is found that with an increase of the post-treatment temperature (e.g., to about 450° C. and above), the irreversible capacity loss during the 1^{st} cycle of a 350° C.-heated sample (e.g., TiO₂-1-350C in Example 1) is reduced. The capacity loss during the 1^{st} cycle is reduced from about 22% for the sample TiO₂-1-350C to about 15% for a 450° C.-heated sample (e.g., TiO₂-1-450C in Example 1) when the post-treatment temperature is increased from 350° C. to 450° C. Here, TiO₂-1-350C and TiO₂-1-450C represent that TiO₂(B) is heated at 350° C. and 450° C., respectively. With the increase of the post-treatment temperature, however, the TiO₂(B) crystal structure is transformed into an anatase crystal structure. The anatase crystal structure is not preferred.

TiO₂(B) crystal structure and anatase crystal structure have different XRD patterns. Each crystal structure has a set of peaks with fixed positions. Anatase crystal structure has several overlapped peaks with TiO₂(B) crystal structure, but they also have several peaks at different positions. The anatase crystal structure has one peak centered at around 38 degrees (2θ) with relatively strong intensity, while the TiO₂(B) crystal structure does not have any peak with strong intensity at this position. Therefore, the peak at about 38 degrees is used as the characteristic peak for the anatase. The existence of anatase crystal structure can also be observed in the electrochemical properties of a TiO₂ material. For example, an anatase will have a lithium de-intercalation potential at about 1.91V vs. Li/Li⁺ at a slow charge rate. The potential could be increased to about 2.06 V vs. Li/Li⁺ when the charge rate is increased.

The TiO₂(B) crystal structure in the described embodiments is maintained at a high temperature (e.g., about 450° C. and above) after being doped with niobium (Nb). The high temperature-treated Nb-doped TiO₂(B) shows reduced capacity loss (e.g., about 15%) during the 1^{st} cycle as compared to the TiO₂(B) post-treated at 350° C. (e.g., about 22%). When the synthesized TiO₂ without Nb doping is heated at 450° C. in air for 2 hours, it shows an anatase crystal structure. With a small amount of Nb (e.g., Nb/Ti molar ratio=1/9) doped in the synthesized TiO₂, the heated TiO₂ shows a significant portion of TiO₂(B) crystal structure, which is characterized by its XRD pattern and its electrochemical properties. With an increased amount of Nb (e.g., Nb/Ti=1/3), the characteristic XRD peak from the anatase crystal structure of the heated TiO₂ becomes negligible. Maintaining the Nb/Ti molar ratio at 1/3, but increasing the heating temperature, even at a much higher temperature (e.g., 650° C.), the TiO₂(B) crystal structure is still maintained. Since all Nb-doped TiO₂ materials including the Nb-doped TiO₂ materials heated at 650° C. do not show XRD peaks from crystallized Nb₂O₅ crystal phase, Nb is chemically incorporated into the TiO₂ crystal structure rather than simply mixed together physically. It is believed that Ti—O—Nb bonds are present in the Nb-doped TiO₂ materials.

In one exemplary embodiment, the Nb/Ti molar ratio in the Nb—TiO₂(B) is in the range of 1/19 to 1/1, and preferably to be in the range of 1/9 to 1/2. The TiO₂(B) structure may not be stabilized with too little Nb (e.g., Nb/Ti molar ratio<1/19) at a high temperature (e.g., >350° C.). For example, the TiO₂ sample with a small amount of Nb (e.g., Nb/Ti molar ratio=1/19) mainly shows TiO₂ (anatase) structure in its XRD pattern when heated at 450° C. in air. More Nb doped in the TiO₂ generally helps stabilize the TiO₂(B) crystal structure at a high temperature. For example, the TiO₂ sample with Nb/Ti molar ratio of 1/9 shows a mixture of the anatase and TiO₂(B) structures at 450° C., but shows only the anatase structure at 550° C. With an increased amount of Nb (e.g., Nb/Ti molar ratio of 1/3), the material maintains pure TiO₂(B) structure even at 650° C. An excessive amount of Nb (e.g., Nb/Ti molar ratio>1/1), however, is not preferred because the cost of Nb is significantly higher than Ti, and due to the high probability that TiO₂(B) will be transformed into other compounds such as TiNb₂O₇.

In at least one embodiment, materials with micro-scaled particle or aggregate sizes may be used to help filter the formed Nb-doped TiO₂ small aggregates. In one exemplary embodiment, the material includes a carbonaceous material. The carbonaceous material generally has an average aggregate size or particle size in the range of micrometers (e.g., from 1 μm to 1000 μm). An aggregate refers to a particle composed of at least two smaller particles. Examples of suitable carbonaceous materials include activated carbon, graphite, hard carbon, soft carbon, amorphous carbon coated graphite, amorphous carbon coated hard carbon, carbon black, carbon nanofibers, carbon nanotubes, graphene, carbon nanoparticles, carbon onion, crystalline carbon, carbon nanocrystals, semi-crystalline carbon, amorphous carbon and the like, but is not limited thereto. The carbonaceous material is preferred to be incorporated into the Nb-doped TiO₂(B) during the solvothermal process, which means that the carbonaceous material may be dispersed in the reaction solution before the thermal treatment process. The presence of these micro-sized carbonaceous particles/aggregates may help collect the TiO₂ particles by using filtration. Depending on reaction conditions, aggregates with <8 μm sizes may be formed during the solvothermal process. For example, TiO₂(B) aggregates with sizes about 0.3-3 μm were reported by Ren et al. (Ren et al., “Nanoparticulate TiO₂(B): An Anode for Lithium-Ion Batteries”, Angewandte Chemie International Edition, vol. 51, (Jan. 17, 2012), pp. 2164-2167). These small aggregates may readily pass through a regular filtering paper with particle retention of 8 to 12 μm. With the incorporation of micro-sized carbonaceous particles/aggregates in the reaction solution, TiO₂ may be formed on these microparticles resulting in the formation of large aggregates (e.g., >8 μm) that may be readily collected by filtering the dispersion through a regular filtering paper or filtering cloth, which may save production costs when the synthesis is scaled up.

In one exemplary embodiment, the Nb-doped TiO₂(B) material includes at least one more element selected from vanadium, chromium, manganese, iron, cobalt, nickel, copper, zinc, zirconium, niobium, molybdenum, tungsten, aluminum, gallium, tin, antimony, silicon, fluoride, and bismuth, but is not limited thereto. The addition of these elements may help improve the cycling stability or/and the rate capability of the Nb-doped TiO₂(B) material.

In one exemplary embodiment, the Nb-doped TiO₂(B) material may be coated with a thin layer of inorganic coating. For example, a carbonaceous coating is applied to coat the Nb-doped TiO₂(B) to improve its rate capability or/and to protect the surface of Nb-doped TiO2 particles from the electrolyte.

In one exemplary embodiment, the Nb-doped TiO₂(B) material may have particle sizes with at least one dimension in a nanometer range (i.e., 1 to 1000 nm).

In at least one exemplary embodiment, the Nb-doped TiO₂(B) material may have various particle morphologies such as nanoparticles, nanoplates, and nanosheets. TiO₂(B) nanoparticles with a particle size of about 3 nm have been synthesized from the solvothermal process described by Ren et. al. (“Nanoparticulate TiO₂(B): An Anode for Lithium-Ion Batteries”, Angewandte Chemie International Edition, vol. 51, (Jan. 17, 2012), pp. 2164-2167). TiO₂(B) nanosheets have been synthesized by Liu et al. (“Nanosheet-Constructed Porous TiO₂—B for Advanced Lithium Ion Batteries”, Advanced Materials, vol. 24, (May 18, 2012), pp. 3201-3204), which are both incorporated herein by reference in their entirety. With Nb doping, it is believed that Nb-doped TiO₂(B) particles may have similar sizes and morphologies as un-doped TiO₂(B).

In one exempary embodiment, the Nb-doped TiO₂(B) material may have an aggregate size on a micrometer (μm) scale (e.g., ≧1 μm). Large aggregates may be obtained by heating the Nb-doped TiO₂(B) at high temperature or by adding solid microparticles (e.g., carbon particles) into the Nb-doped TiO₂ to form a core-shell structure.

### Solvothermal Process

A solvothermal process is a process to synthesize materials in a liquid solution with heating. This process is also called a hydrothermal process when it is carried out in a sealed container.

In the described embodiments of the present invention, the Nb-doped TiO₂(B) particles are synthesized from the solvothermal process (i.e., as-synthesized particles) following a heating post-treatment step. The heating post-treatment step is necessary to remove organic impurities contained in the as-synthesized particles.

In one exemplary solvothermal process, a titanium source TiCl₄ and a niobium source NbCl₅ are dissolved in ethylene glycol to form a clear solution. At least part of the Cl⁻ ions in the TiCl₄ and NbCl₅ are replaced by ethylene glycol during the dissolving process. After forming the clear solution, a carbonaceous material may be optionally dispersed in the clear solution. Water or aqueous ammonia is then added into the dispersion under stifling to induce hydrolysis and condensation reactions of the Ti and Nb species, i.e., the titanium source TiCl₄ and the niobium source NbCl₅. The obtained solution is then heated in an oil bath at about 185° C. and refluxed for 4 hours in open air to form particles in the obtained solution. Preferably, the obtained solution is heated in an oil bath at a temperature ranging from 100° C. to 200° C. More preferably, the obtained solution is heated in an oil bath at a temperature ranging from 110° C. to 185° C. The formed colloidal particles or precipitates are collected by filtering the obtained solution with a regular filtering paper. The collected colloidal particles or precipitates are dried at a relatively mild temperature (e.g., about 110° C. to 200° C.) and then heated at 450° C. in air for 2 hours to form the Nb-doped TiO₂(B) particles. The formed Nb-doped TiO₂(B) particles have a TiO₂(B) crystal structure, which is characterized with at least one characteristic XRD peak at about 28.6 degrees or 44.0 degrees (2θ) when measured using CuKα radiation.

In the above process, a titanium-ethylene glycol complex (e.g., titanium-glycolate) is formed after dissolving TiCl₄ in ethylene glycol. The formation of titanium-ethylene glycol complex or a complex with similar chemical structures (e.g., a complex formed between titanium and glycolic acid) seems to be necessary for the synthesis of the Nb-doped TiO₂(B). When the ethylene glycol is replaced by other organic solvents such as ethanol and glycerol, the obtained Nb-doped TiO₂(B) product lacks the TiO₂(B) crystal structure.

Besides TiCl₄, other titanium sources may also be used as long as they may dissolve in ethylene glycol or form a complex with glycolic acid. For example, titanium chloride (e.g., TiCl₃) may be used as the titanium source. Furthermore, the titanium source may be selected from, but is not limited to titanium alkoxide (e.g., titanium ethoxide, titanium isopropoxide, and titanium butoxide), titanium acetylacetonate, titanium bis(acetylacetonate)dichloride, and titanium glycolate, and combinations thereof. Titanium in these compounds may have a +4 oxidation or +3 oxidation state.

The niobium source may be selected from, but is not limited to niobium chloride, niobium alkoxide (e.g., niobium ethoxide, niobium isopropoxide, and niobium butoxide), niobium acetylacetonate, niobium bis(acetylacetonate)dichloride, niobium glycolate, and combinations thereof.

The solvent is preferred to be ethylene glycol unless the titanium source is titanium glycolate. Water can be used as the solvent if the titanium source is titanium glycolate.

After the formation of titanium-ethylene glycol complex, water is needed to induce the hydrolysis and condensation reactions of the Ti and Nb species, so that Nb-doped TiO₂ is produced. The addition of the water can be done by adding water or aqueous ammonia into the solution. An aqueous alkaline solution may be used, but not preferred because alkaline metal ions need to be removed after the solvothermal process as a contamination source, which may raise the production cost.

The above reaction is preferred to be carried out at a temperature of about 110° C. and above to form crystallized particles. We have synthesized Nb-doped TiO₂(B) at a mild temperature (e.g., about 120° C.) in open air without refluxing. This temperature (e.g., about 120° C.) is lower than what has been reported in the literature for the synthesis of TiO₂(B), which generally uses a heating temperature of at least 140° C. (Xiang et al., “Large-scale synthesis of metastable TiO2(B) nanosheets with atomic thickness and their photocatalytic properties”, Chemical Communications, vol. 46, (Aug. 23, 2010), pp. 6801-6803). An even lower reaction temperature such as 100° C. might be possible by optimizing the reaction conditions. When using the ethylene glycol as the solvent, the reaction can be carried out either in open air or in a sealed container. When using water as the pure solvent, it is preferable that the reaction is carried out in a sealed container so that the reaction temperature may be above 100° C.

The formed Nb-doped TiO₂(B) particles in the dispersion may be collected by filtration. With the use of pure water to induce the hydrolysis and condensation reactions, the formed particles may be too small to be collected by using a regular filtering paper. In this case, a material with micro-sized aggregate/particle sizes might be added into the reaction solution, so that the TiO₂ particles are formed or adsorbed onto these micro-sized aggregates/particles, which can be filtered with a regular filtering paper. The formed Nb-doped TiO₂(B) particles can be collected by other collection techniques including centrifuging, spray-drying, and freeze-drying, but these are expected to be more costly than the filtration technique.

The collected particles are expected to have a TiO₂(B) crystal structure. They have organic impurities as evidenced by Fourier Transform Infrared (FTIR) spectrum. A heating post-treatment process is necessary to remove the organic impurities. The heating temperature for the Nb-doped TiO₂(B) is >350° C., more preferably ≧400° C., and even more preferably from 450° C. to 650° C.

In one exemplary embodiment, a molar ratio of niobium/titanium is in a range of about 1/19 to about 1/1. A higher molar ratio may be used, but is not preferred considering the high cost of Nb.

In one exemplary embodiment, the solvent is ethylene glycol.

In one exemplary embodiment, water is added to induce the hydrolysis and condensation reactions of Ti and Nb species.

In one exemplary embodiment, aqueous ammonia is added to induce the hydrolysis and condensation reactions of the Ti and Nb species.

In one exemplary embodiment, the reaction solution is heated at a temperature of about 110° C. and above.

In one exemplary embodiment, the reaction solution is refluxed. The refluxing time may be in the range from tens of minutes (e.g., 30 minutes) to tens of hours (e.g., 24 hours).

In one exemplary embodiment, the generated TiO₂ particles are collected by filtration.

In one exemplary embodiment, the collected TiO₂ particles are dried and then heated at a temperature >350° C. in air for a few hours (e.g., 2 hours). A heating temperature ranging from about 400° C. and about 650° C. is preferred for a removal of organic impurities. The heating process may also be carried out in vacuum or in an inert environment including argon.

The described embodiments of the present invention are further illustrated by the following Examples.

### Example 1

### TiO₂/Carbon Black Treated at Various Temperatures

TiO₂/carbon black was prepared according to Liu et al., “Nanosheet-Constructed Porous TiO₂—B for Advanced Lithium Ion Batteries”, Advanced Materials, vol. 24, (May 18, 2012), pp. 3201-3204, which is incorporated herein by reference in its entirety. More specifically, 1 ml TiCl₄ was dissolved in 80 ml ethylene glycol. Acetylene black was then dispersed in the solution as needed, followed by adding 1.8 g aqueous ammonia (28 wt %) under stirring. The obtained solution was refluxed at about 185° C. to 190° C. in open air for 4 hours. Generated particles were collected by vacuum filtration with a regular filter paper (particle retention: 8 to 12 μm). The generated particles were dried at 110° C. overnight and then heated at either 350° C. or 450° C. in air for 2 hours. The obtained samples are named as TiO₂-1-110C, TiO₂-1-350C, and TiO₂-1-450C.

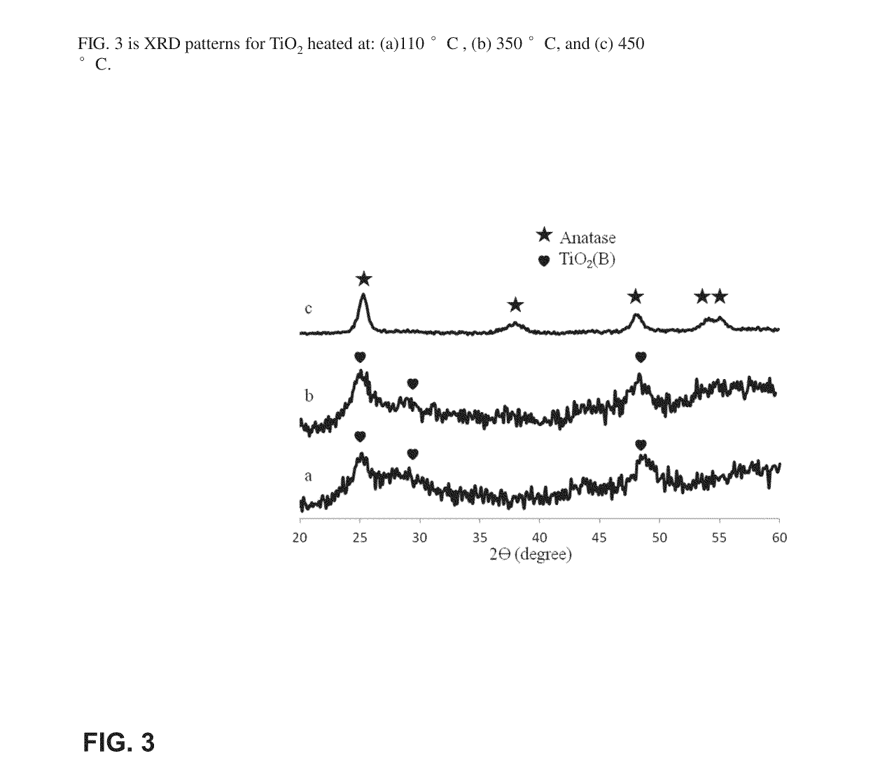

XRD patterns for the TiO₂ samples heated at 110° C., 350° C. and 450° C. are shown in FIG. 3. As shown, patterns a, b, and c represent the patterns of the TiO₂-1-110C, TiO₂-1-350C, and TiO₂-1-450C, respectively. XRD peaks from the samples TiO₂-1-110C and TiO₂-1-350C may be attributed to a TiO₂(B) crystal structure. The presence of the characteristic XRD peak for an anatase crystal structure is not identified at the position at about 37.9 degrees (2θ) for samples TiO₂-1-110C and TiO₂-1-350C. In comparison, all XRD peaks from sample TiO₂-1-450C may be attributed to the anatase crystal structure, which shows that the obtained TiO₂(B) crystal structure was not stable at 450° C.

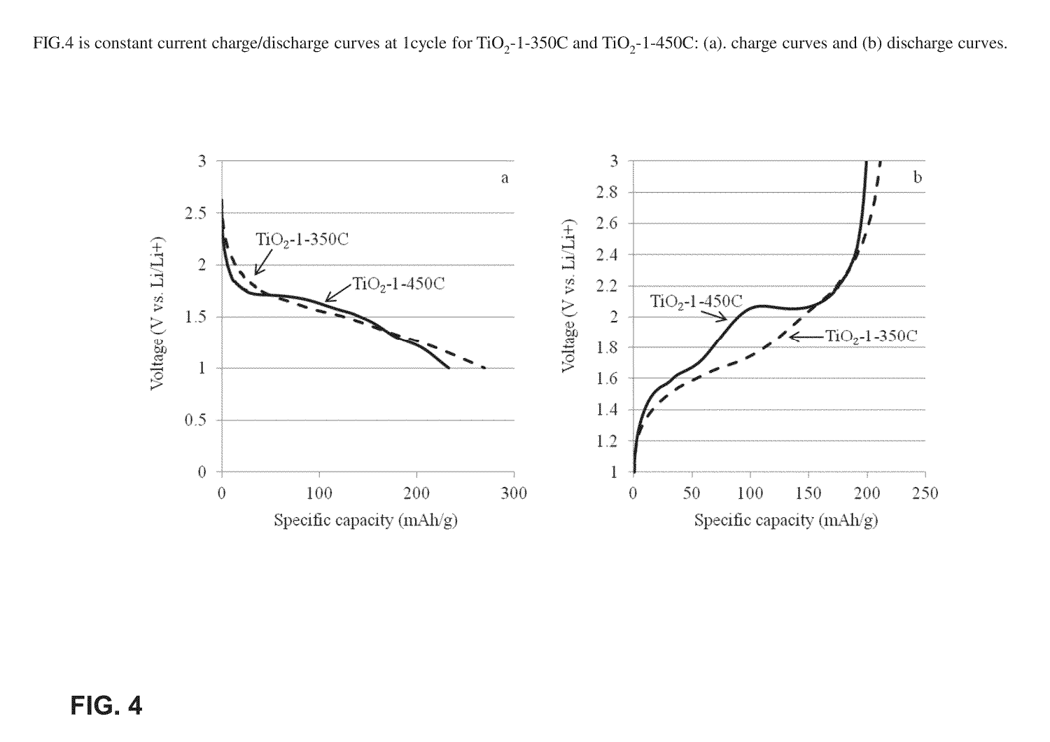

Constant current charge/discharge curves for samples TiO₂-1-350C and TiO₂-1-450C are shown in FIG. 4A and FIG. 4B. The constant current charge/discharge curves were collected in a half cell with lithium as the negative electrode at a charge/discharge rate of 1 A/g. The sample TiO₂-1-350C showed a smoothly decreased or increased voltage profile for the lithium insertion (FIG. 4A) or extraction (FIG. 4B) process. The average lithium insertion potential was about 1.48V and the average lithium extraction potential was about 1.83V, which is higher than the expected lithium extraction potential for TiO₂(B) (i.e., about 1.65V vs Li/Li⁺). This suggests that the TiO₂-1-350C sample might include other titannate phases such as the anatase crystal structure that raised its average lithium extraction potential.

In comparison, the sample TiO₂-1-450C showed a flat voltage plateau at about 1.71V (vs. Li/Li⁺) during the lithium insertion process (FIG. 4A) and a flat voltage plateau at about 2.06V (vs. Li/Li⁺) during the lithium extraction (FIG. 4B) process. The flat voltage plateaus at about 1.71V and 2.06V are the characteristic lithium intercalation and de-intercalation potentials for the anatase crystal structure. The slight difference between the observed voltage plateaus and the expected voltage plateaus for TiO₂ (anatase) (i.e., 1.78V/1.91V) is because of the relatively fast charge/discharge rate (1 A/g) used in the current test. It is apparent that the TiO₂-1-450C also showed features from the TiO₂(B): a relatively flat voltage slope centered at about 1.6V may be contributed from the TiO₂(B). The average lithium extraction potential for the TiO₂-1-450C was about 1.92V (vs. Li/Li⁺), which is higher than the average lithium extraction potential (about 1.83 V vs. Li/Li⁺) for the TiO₂-1-350C.

Columbic efficiencies during the 1^{st} cycle for the samples TiO₂-1-350C and TiO₂-1-450C are shown in Table 1. With an increased heating temperature, the columbic efficiency during the 1^{st} charge/discharge cycle increased from 77.9% to 84.9%. This shows that the capacity loss during the 1^{st} cycle could be reduced by the increased heating temperature for the TiO₂(B).

TABLE 1

| | Columbic efficiency @ | Charging capacity @ |
|---|---|---|
| Sample | 1^{st} cycle (%) | 1^{th} cycle (mAh/g) |
| TiO₂-1-350 C. | 77.9 | 202 |
| TiO₂-1-450 C. | 84.9 | 187 |

### Example 2

### TiO₂-2-450C and Nb_{0.1}Ti_{0.9}O₂-2-450C

TiO₂-2-450C and Nb_{0.1}Ti_{0.9}O₂-2-450C were prepared by the solvothermal process. In one exemplary process for synthesizing TiO₂, about 2.6 ml TiCl₄ was dissolved in 30 ml ethylene glycol. 5.4 g aqueous ammonia (28 wt %) was then added into the above solution under stirring. The obtained solution was refluxed (e.g., at about 185° C.) in open air for 4 hours. Particles were collected by vacuum filtration with a regular filter paper (particle retention: 8 to 12 μm). The generated particles were dried at 110° C. overnight and then heated at 450° C. in air for 2 hours. The preparation procedure for Nb_{0.1}Ti_{0.9}O₂ was the same as TiO₂ except that 0.72 g NbCl₅ was added in ethylene glycol as the source for Nb, besides adding TiCl₄. The 450° C.-heated samples are named as TiO₂-2-450C and Nb_{0.1}Ti_{0.9}O₂-2-450C.

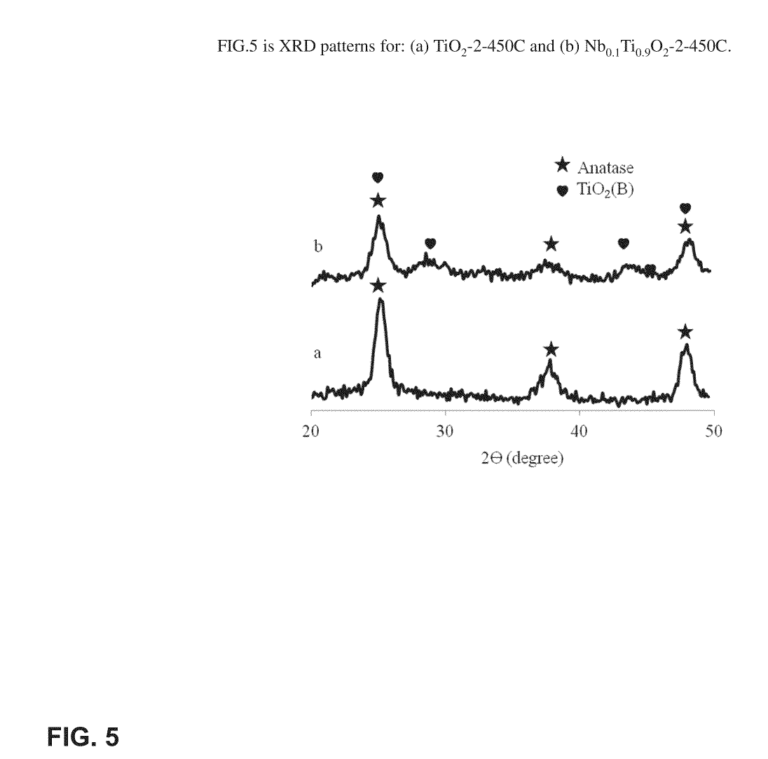

XRD patterns for TiO₂-2-450C and Nb_{0.1}Ti_{0.9}O₂-2-450C are shown in FIG. 5. The XRD pattern for TiO₂-2-450C might be a good fit for an anatase-only crystal structure, while the XRD pattern for Nb_{0.1}Ti_{0.9}O₂-2-450C shows a mixture of the anatase crystal structure and TiO₂(B) crystal structure.

The formation of the anatase crystal structure is the same as was shown in Example 1. The TiO₂(B) made from the solvothermal process was not stable at 450° C. With the addition of a small amount of Nb (i.e., molar ratio of Nb/Ti=1/9), the stability of the TiO₂(B) became much better, which is shown by the characteristic XRD peaks at about 28.6 degrees (2θ) and about 44.0 degrees (2θ) for the sample Nb_{0.1}Ti_{0.9}TiO₂-450C when measured using CuKα radiation.

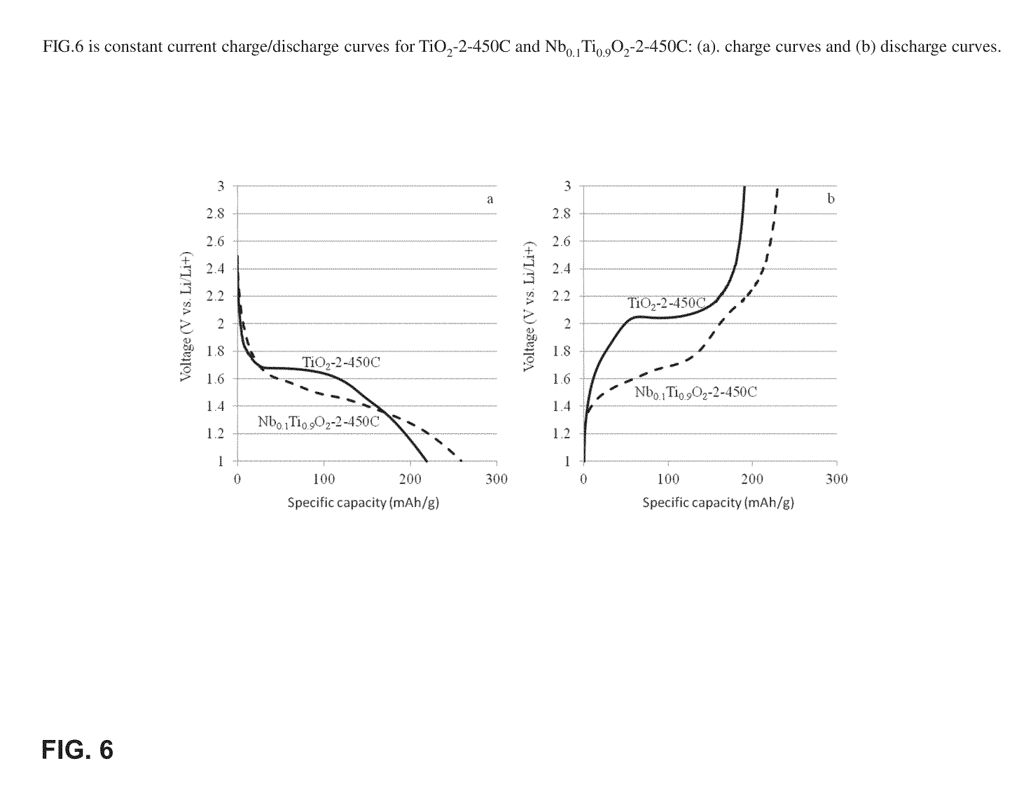

Constant current charge/discharge curves for samples TiO₂-2-450C and Nb_{0.1}Ti_{0.9}O₂-2-450C are shown in FIG. 6A and FIG. 6B. The constant current charge/discharge curves for the sample TiO₂-2-450C are different from the sample TiO₂-1-450C discussed in Example 1. The relatively flat voltage slope centered at about 1.6 V is not shown in the lithium extraction curve (i.e., charge curve) for the sample TiO₂-2-450C, suggesting that TiO₂-2-450C is mainly the anatase crystal structure. The difference may result from the difference in reactant concentrations used for the synthesis. In this example, the reactants were about eight-times as concentrated as those in Example 1, which may favor the formation of the anatase crystal structure. The average lithium insertion/extraction potential is about 2.04V for the sample TiO₂-2-450C, which is higher than the average potential for the sample TiO₂-1-450C. With the addition of Nb, the sample Nb_{0.1}Ti_{0.9}O₂-2-450C shows a relatively flat slope ranging from 1.3V to 1.8V and another flat slope centered at about 2.07V. The slope ranging from 1.3V to 1.8V is considered to come from the TiO₂(B) crystal structure, while the one centered at about 2.07V can be attributed to the anatase crystal structure. The presence of a significant amount of TiO₂(B) structure in Nb_{0.1}Ti_{0.9}O₂-2-450C was confirmed by its constant current charge/discharge curves.

Columbic efficiencies for the samples TiO₂-2-450C and Nb_{0.1}Ti_{0.9}O₂-2-450C during the 1^{st} cycle are shown in Table 2. A columbic efficiency of about 88.7% was observed for the sample Nb_{0.1}Ti_{0.9}O₂-2-450C, which is higher than 77.9% observed for the TiO₂-1-350C tested under similar conditions.

TABLE 2

| | Columbic efficiency @ | Charging capacity @ |
|---|---|---|
| Sample | 1^{st} cycle (%) | 1^{th} cycle (mAh/g) |
| TiO₂-2-450 C. | 86.7 | 190 |
| Nb_{0.1}Ti_{0.9}O₂-2-450 C. | 88.7 | 230 |

### Example 3

### Nb-Doped TiO₂ with Various Nb/Ti Molar Ratios

Five samples were made with various molar ratios of Nb/Ti (e.g., about 100/0, 50/50, 25/75, 10/90, and 5/95) through the solvothermal process. The amounts of reactants are listed in Table 3. As-synthesized samples before the heating post-treatment step are identified as Nb₁Ti₀, Nb₁Ti₁, Nb₁Ti₃, Nb₁Ti₉, and Nb₁Ti₁₉, respectively.

TABLE 3

| | Sample | | | | |
|---|---|---|---|---|---|
| | Nb1Ti19 | Nb1Ti9 | Nb1Ti3 | Nb1Ti1 | Nb1Ti0 |
| NbCl5 (g) | 0.12 | 0.24 | 0.58 | 1.10 | 1.97 |
| TiCl4 (ml) | 0.94 | 0.88 | 0.71 | 0.45 | 0 |
| Acetylene black | 0.11 | 0.11 | 0.11 | 0.11 | 0.11 |
| Ethylene glycol (ml) | 80 | 80 | 80 | 80 | 80 |
| Aqueous ammonia | 1.8 | 1.8 | 1.8 | 1.8 | 1.8 |
| (about 28 wt %) | | | | | |

Samples Nb₁Ti₀-450C, Nb₁Ti₁-450C, Nb₁Ti₃-450C, Nb₁Ti₉-450C, and Nb₁Ti₁₉-450C were obtained by heating Nb₁Ti₀, Nb₁Ti₁, Nb₁Ti₃, Nb₁Ti₉, and Nb₁Ti₁₉ at 450° C. in air for 2 hours, respectively. Samples Nb₁Ti₀-450C, Nb₁Ti₁-450C, Nb₁Ti₃-450C, and Nb₁Ti₉-450C were then heated at 550° C. for 2 hours in air to form Nb₁Ti₀-550C, Nb₁Ti₁-550C, Nb₁Ti₃-550C, and Nb₁Ti₉-550C, respectively. Samples Nb₁Ti₁-550C, Nb₁Ti₃-550C, and Nb₁Ti₉-550C were further heated at 650° C. for 2 hours in air to form Nb₁Ti₁-650C, Nb₁Ti₃-650C, and Nb₁Ti₉-650C, respectively.

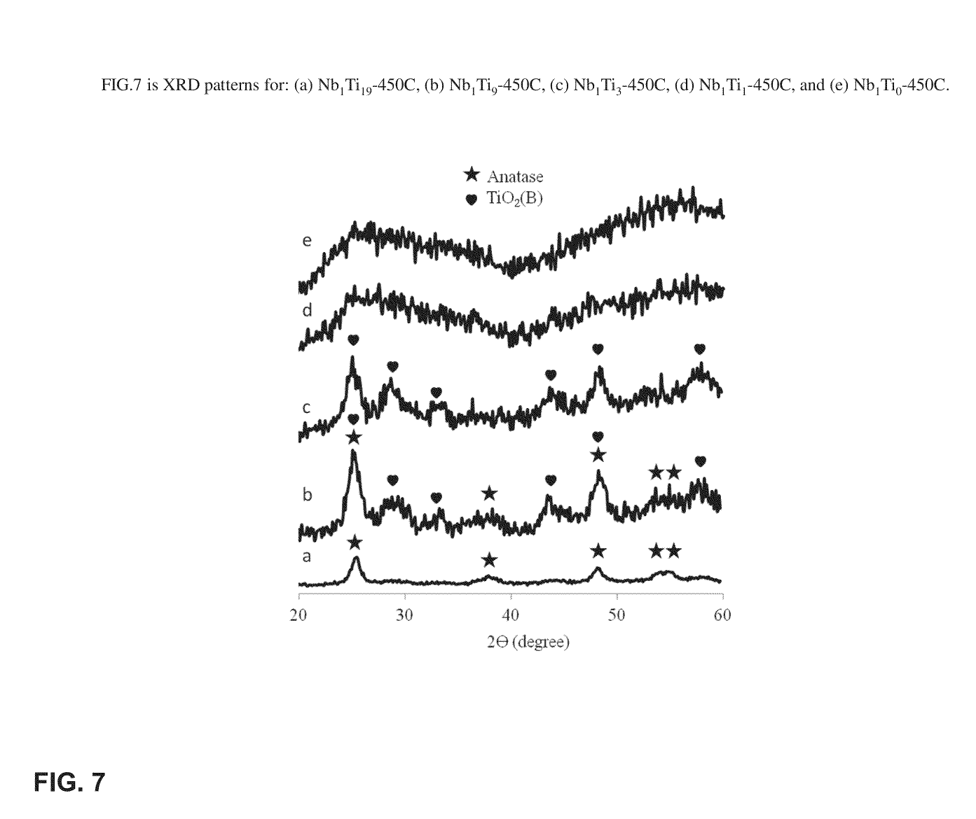

XRD patterns for the materials heated at 450° C. are shown in FIG. 7. With the molar ratio of Nb/Ti=1/19, the sample (i.e., Nb₁Ti₁₉-450C) shows mainly XRD peaks from an anatase crystal structure. With an increased amount of Nb (i.e., Nb₁Ti₉-450C), the characteristic peaks from TiO₂(B) becomes clear. With a further increased amount of Nb (i.e., Nb₁Ti₃-450C), the characteristic peak from the anatase crystal structure (i.e., about 37.9 degrees at 2θ) becomes negligible. With the molar ratio of Nb/Ti=1/1, the sample (i.e., Nb₁Ti₁-450C) shows mainly an amorphous feature, which is similar to the pattern for the niobium oxide sample (i.e., Nb₁Ti₀-450C).

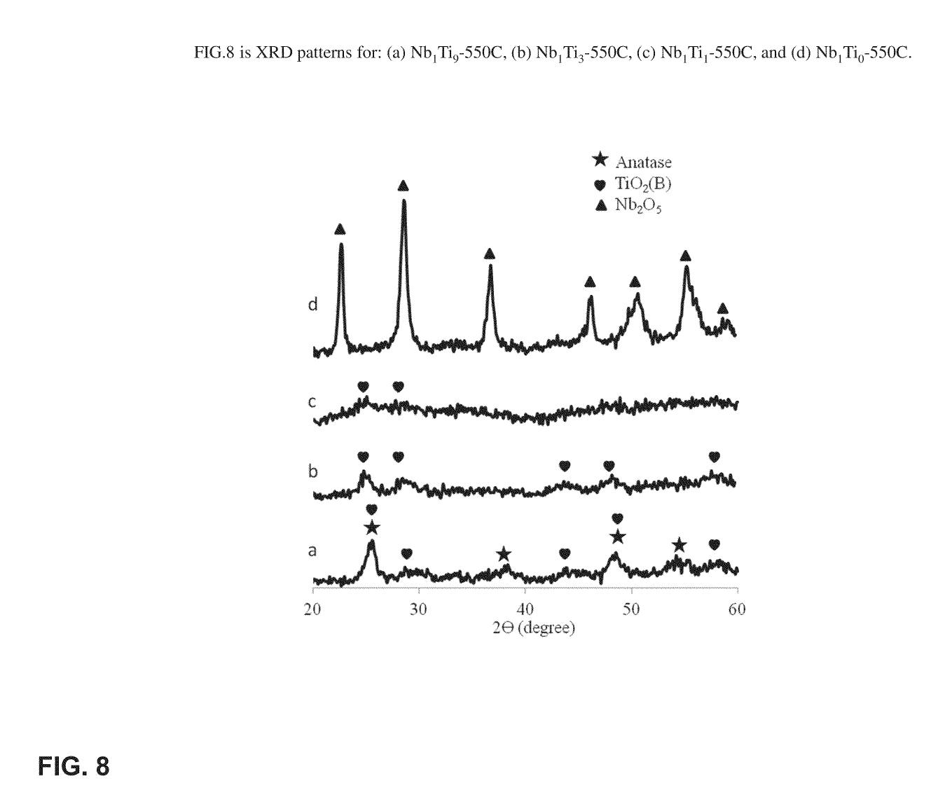

XRD patterns for the samples heated at 550° C. are shown in FIG. 8. With an increased heating temperature, the characteristic peak from the anatase crystal structure (i.e., about 37.9 degrees at 2θ) in the sample Nb₁Ti₉-550C becomes clear as compared to the sample Nb₁Ti₉-450C. This characteristic peak from the anatase crystal structure in the sample with more Nb (i.e., Nb₁Ti₃-550C), however, is still negligible. All Nb-incorporated TiO₂ samples (i.e., Nb₁Ti₉-550C, Nb₁Ti₃-550C, and Nb₁Ti₁-550C) do not show any characteristic peak from Nb₂O₅, which is shown as the crystal structure for Nb₁Ti₀-550C. This suggests that Nb₂O₅ has been substantially doped into the TiO₂ structure. Otherwise peaks from Nb₂O₅ should be observed from the Nb-incorporated TiO₂ samples since Nb₂O₅ became highly crystallized under the heating conditions.

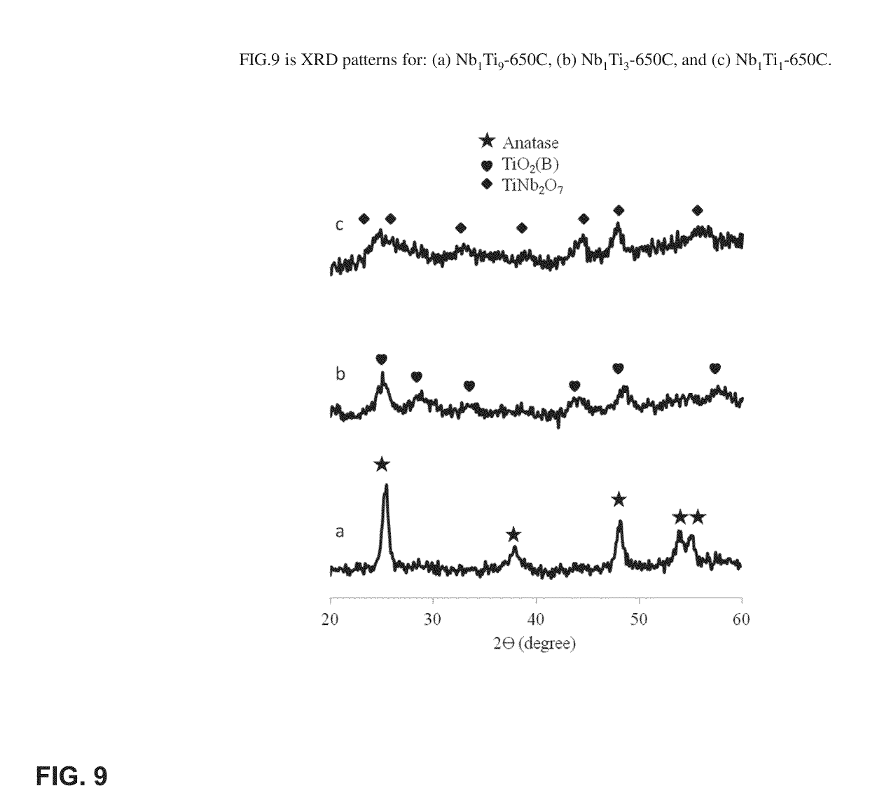

XRD patterns for the samples heated at 650° C. are shown in FIG. 9. The sample Nb₁Ti₉-650C shows a pure anatase crystal structure. No TiO₂(B) characteristic peak is observed, suggesting that the TiO₂(B) in Nb₁Ti₉-550C has been transformed into an anatase crystal structure with the increased heating temperature. Interestingly, the sample Nb₁Ti₃-650C still does not show the presence of the anatase crystal structure; the characteristic peak from the anatase crystal structure (i.e., about 37.9 degrees at 20) is not clear. FIG. 9 shows that the TiO₂(B) structure might be maintained at a temperature as high as 650° C. by adjusting the amount of Nb in the doped sample. The XRD pattern for the sample Nb₁Ti₁-650C can be indexed as a TiNb₂O₇ crystal structure, which is collected in the JCPDS (i.e., Joint Committee on Powder Diffraction Standards) database with an index number of 00-039-1407 (JCPDS: 00-039-1407), suggesting a lower molar ratio of Nb/Ti (e.g., Nb/Ti<1/1) is desirable to maintain the TiO₂(B) structure.

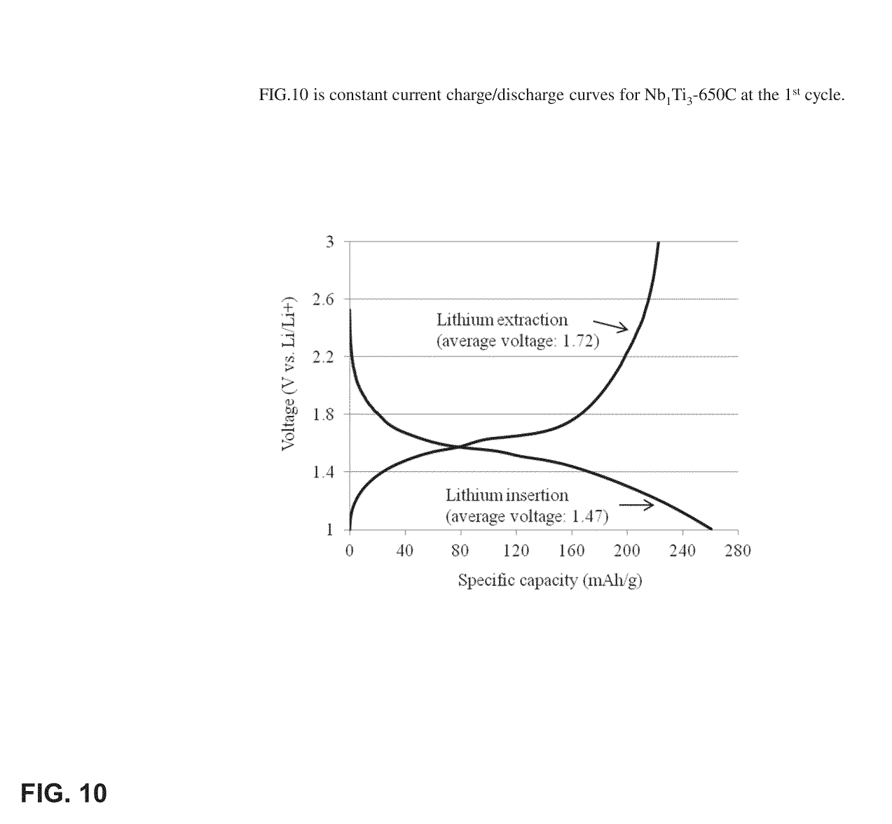

The lack of a significant amount of the anatase crystal structure in the sample Nb₁Ti₃-650C is confirmed in its constant current charge/discharge curves (FIG. 10). The characteristic flat voltage plateau from the anatase crystal structure (i.e., at about 2.0 V vs. Li/Li⁺ in the charge curve) is not present. The columbic efficiency for the sample Nb₁Ti₃-650C is about 85%, which is higher than 77.9% observed for TiO₂-1-350C tested under similar conditions.

As described above in the described embodiments and examples of the present invention, the thermal stability of the TiO₂(B) has been greatly improved after being doped with Nb. The TiO₂(B) crystal structure may be maintained at least up to a temperature of 650° C. when doped with a moderate amount of Nb (e.g., Nb/Ti molar ratio=1/3). In comparison, the TiO₂(B) structure was not stable even at a temperature of 450° C. without Nb doping.

Because of the presence of Nb, a relatively high heating temperature (e.g., 450° C. to 650° C.) can be used to generate T₁O₂(B). The generated Nb-doped TiO₂(B) exhibits a relatively high columbic efficiency during the 1^{st} charge/discharge cycle. A columbic efficiency of about 85% or higher is routinely observed for the Nb-doped TiO₂(B), which is much better than the columbic efficiency of about 77.9% for TiO₂(B) treated at 350° C. under similar testing conditions.

In summary, in the described embodiments of the present invention, the columbic efficiency for the 1^{st} charge/discharge cycle may be improved by heating the generated TiO₂(B) at a high temperature (e.g., ≧450° C.). Doping with Nb is found to be effective in maintaining the TiO₂(B) crystal structure during the high temperature treatment process. By adjusting the amount of doped Nb, the TiO₂(B) structure may be maintained at least from 450° C. to 650° C.

The invention has been described by way of several embodiments and examples. For example:

At least one embodiment includes an energy storage device having a positive electrode including an active material that stores and releases ions, a negative electrode including Nb-doped TiO₂(B), and a non-aqueous electrolyte containing lithium ions.

The energy storage device includes a lithium ion battery and lithium ion capacitor.

The negative active electrode material includes at least niobium oxide and titanium oxide.

The negative active electrode material includes Nb-doped TiO₂ with a crystal structure same as TiO₂(B).

The negative electrode material includes Nb-doped TiO₂ with a monoclinic crystal structure.

The negative active electrode material includes Nb-doped TiO₂(B) with at least one characteristic XRD peak at about 28.6 degrees or 44.0 degrees (2θ) when measured using CuKα radiation.

The negative active electrode material includes Nb-doped TiO₂(B) having a molar ratio of Nb/Ti ranged from about 1/19 to about 1/1.

The negative active electrode material includes Nb-doped TiO₂(B) and at least one carbonaceous material. The carbonaceous material may be selected from activated carbon, carbon black, carbon nanotubes, carbon nanofibers, graphite, graphene, carbon nanocrystals, carbon nanoparticles, carbon onions, crystalline carbon, semi-crystalline carbon, and amorphous carbon.

The negative active electrode material includes Nb-doped TiO₂(B) and at least one element selected from vanadium, chromium, manganese, iron, cobalt, nickel, copper, zinc, zirconium, niobium, molybdenum, tungsten, aluminum, gallium, tin, antimony, and bismuth.

The negative electrode material includes Nb-doped TiO₂(B) coated with a thin layer of inorganic coating including carbon coating.

At least one embodiment includes a lithium ion capacitor having a positive electrode active material including a carbonaceous material, a negative electrode including Nb-doped TiO₂(B), and a non-aqueous electrolyte containing lithium ions.

The lithium ion capacitor may include a positive electrode having an electrically conductive substrate. The electrically conductive substrate may include plate, sheet, foil, mesh, expanded mesh, felt, and foam made from a series of electrically conductive substances such as copper, nickel, aluminum, iron, stainless steel, titanium, graphite, carbon black, carbon nanotubes, graphene, or conductive polymer.

The lithium ion capacitor may include a positive electrode active material, which is a carbonaceous material with a specific surface area greater than 100 m²/g, or more preferably between 1000 m²/g and 3500 m²/g. The carbon film may include activated carbon, carbon nanotubes, graphene, carbon black, carbon nanoparticles, or carbon nanocrystals.

At least one embodiment includes a lithium ion battery having a positive electrode active material that stores energy through a faradaic process, a negative electrode including Nb-doped TiO₂(B), and a non-aqueous electrolyte containing lithium ions.

The lithium ion battery may include a positive electrode having a lithium intercalation material that can store/release lithium ions through an intercalation/de-intercalation process. The positive electrode may include an electrochemically-active layer and an electrically conductive substrate. The electrochemically-active layer may include a lithium intercalation material that can be selected from existing cathode materials for lithium ion battery, for example: LiFePO₄, LiMn₂O₄, LiMnO₂, LiNiO₂, LiCoO₂, LiMn_{0.5}Ni_{0.5}O₂, LiNi_{0.5}Mn_{1.5}O₄, LiCo_{1/3}Ni_{1/3}Mn_{1/3}O₂, xLi₂MnO₃.(1-x)LiMO₂ (0≦x≦1; M: Mn, Co, Ni), LiV₃O₈, and LiVPO₄F. The electrochemically-active layer may include a non-lithiated material having FePO₄, V₂O₅, or MnO₂.

The lithium ion battery may include a positive electrode having sulfur. A carbon-sulfur composite may generally be used to ensure good electrical conductivity of electrode film.

The lithium ion battery may include a positive electrode having at least one air catalyst that can catalyze either the reduction process of oxygen, or the oxidation process of oxide, or both.

The lithium ion battery may include a positive electrode comprising a metal fluoride that interacts with lithium ions through a conversion reaction.

At least one embodiment includes Nb-doped TiO₂(B) as an electrode active material for an energy storage device.

The electrode active material includes a TiO₂(B) crystal structure with at least one characteristic XRD peaks at about 28.6 degrees (2θ) or about 44.0 degrees (2θ) when measured using CuKα radiation.

The electrode active material includes Nb-doped TiO₂(B) with a molar ratio of Nb/Ti ranged from about 1/19 to about 1/1, preferably from about 1/9 to 1/2.

The electrode active material may include a carbonaceous material selected from, but not limited to activated carbon, carbon black, carbon nanotubes, carbon nanofibers, graphite, graphene, carbon nanocrystals, carbon nanoparticles, carbon onions, crystalline carbon, semi-crystalline carbon, and amorphous carbon.

The electrode active material may include an element selected from vanadium, chromium, manganese, iron, cobalt, nickel, copper, zinc, zirconium, niobium, molybdenum, tungsten, aluminum, gallium, tin, antimony, and bismuth.

Nb-doped TiO₂(B) particles may be coated with a thin layer of inorganic coating (e.g., carbon coating).

Nb-doped TiO₂(B) may have various particle morphologies including nanoparticles and nanoplates.

Nb-doped TiO₂(B) may an average particle size in the nanometer size range (e.g, about 1 to 1000 nm).

At least one embodiment includes a process for making Nb-doped TiO₂(B) including one step of dissolving at least one titanium compound and one niobium compound in ethylene glycol to form a clear solution, one optional step of adding solid particles (e.g., carbon particles) to form a dispersion, one step of adding water or aqueous ammonia into the solution to induce hydrolysis and condensation, one step of heating the solution to produce colloidal particles, one step of collecting the colloidal particles, and one step of heating the colloidal particles at a temperature >350° C.

The titanium compound may be selected, but not limited to titanium chloride, titanium ethoxide, titanium isopropoxide, titanium butoxide, titanium acetylacetonate, titanium bis(acetylacetonate)dichloride, and titanium glycolate. Titanium in these compounds may have either +3 or +4 oxidation states.

The niobium compound may be selected from, but not limited to niobium chloride, niobium ethoxide, niobium isopropoxide, and niobium butoxide, niobium acetylacetonate, niobium bis(acetylacetonate)dichloride, and niobium glycolate.

The solid particles may be selected from a carbonaceous material including activated carbon, carbon black, carbon nanotubes, carbon nanofibers, graphite, graphene, carbon nanocrystals, carbon nanoparticles, carbon onions, crystalline carbon, semi-crystalline carbon, and amorphous carbon.

The solution may be heated at a temperature ranged from 100° C. to 200° C. in open air, preferably about 110° C. to 185° C.

Generated particles may be collected from a process that may be selected from, but not limited to filtration, centrifuging, spray-drying, and freeze-drying.

The dried particles show a TiO₂(B) crystal structure;

The dried colloidal particles may be heated at a temperature >350° C., preferably ≧400° C., and more preferably from 450° C. to 650° C. with a heating time ranged from a few minutes (e.g. 10 minutes) to tens of hours (e.g., 24 hours).

It is understood that the described embodiments are not mutually exclusive, and elements, components, materials, or steps described in connection with one exemplary embodiment may be combined with, or eliminated from, other embodiments in suitable ways to accomplish desired design objectives.

The term “or” is used in this application its inclusive sense (and not in its exclusive sense), unless otherwise specified. In addition, the articles “a” and “an” as used in this application and the appended claims are to be construed to mean “one or more” or “at least one” unless specified otherwise.

It will be further understood that various changes in the details, materials, and arrangements of the parts which have been described and illustrated in order to explain the nature of described embodiments may be made by those skilled in the art without departing from the scope as expressed in the following claims

We claim:

1. An energy storage device, comprising:
a positive electrode including a material that stores and releases ion;
a negative electrode including Nb-doped TiO₂(B); and
a non-aqueous electrolyte containing lithium ions.

2. The energy storage device of claim 1 wherein the energy storage device is a lithium ion battery.

3. The energy storage device of claim 1 wherein the energy storage device is a lithium ion capacitor.

4. The energy storage device of claim 1 wherein the Nb-doped TiO₂(B) has a TiO₂(B) crystal structure with at least one characteristic XRD peaks at about 28.6 degrees or 44.0 degrees (2θ) when measured using CuKα radiation.

5. The energy storage device of claim 1 wherein the Nb-doped TiO₂(B) has a molar ratio of Nb/Ti from about 1/19 to about 1/1.

6. The energy storage device of claim 1 wherein the Nb-doped TiO₂(B) has a molar ratio of Nb/Ti from about 1/9 to about 1/2.

7. The energy storage device of claim 1 wherein the Nb-doped TiO₂(B) comprises particles with particle sizes ranges from 1 nm to 1000 nm.

8. The energy storage device of claim 1 wherein the Nb-doped TiO₂(B) includes a carbonaceous material selected from activated carbon, graphite, hard carbon, soft carbon, amorphous carbon coated graphite, amorphous carbon coated hard carbon, carbon black, carbon nanofibers, carbon nanotubes, graphene, carbon nanoparticles, carbon onion, crystalline carbon, carbon nanocrystals, semi-crystalline carbon, and amorphous carbon.

9. The energy storage device of claim 1 wherein the Nb-doped TiO₂(B) includes an element selected from the group consisting of vanadium, chromium, manganese, iron, cobalt, nickel, copper, zinc, zirconium, niobium, molybdenum, tungsten, aluminum, gallium, tin, antimony, bismuth, and a combination thereof.

10. The energy storage device of claim 1 wherein at least one of the Nb-doped TiO₂(B) particles has a thin layer of inorganic coating thereon.

11. The energy storage device of claim 10 wherein the inorganic coating is a carbonaceous coating.

12. A negative electrode active material for energy storage devices comprising Nb-doped TiO₂(B).

13. The negative electrode active material of claim 12 wherein the Nb-doped TiO₂(B) has a TiO₂(B) crystal structure with at least one characteristic XRD peaks at about 28.6 degrees (2θ) or about 44.0 degrees (2θ) when measured using CuKα radiation.

14. The negative electrode active material of claim 12 wherein the Nb-doped TiO₂(B) has a molar ratio of Nb/Ti ranged from about 1/19 to about 1/1.

15. The negative electrode active material of claim 12 wherein the Nb-doped TiO2(B) has a molar ratio of Nb/Ti ranged from about 1/9 to about 1/2.

16. The negative electrode active material of claim 12, further comprising a carbonaceous material selected from activated carbon, graphite, hard carbon, soft carbon, amorphous carbon coated graphite, amorphous carbon coated hard carbon, carbon black, carbon nanofibers, carbon nanotubes, graphene, carbon nanoparticles, carbon onion, crystalline carbon, carbon nanocrystals, semi-crystalline carbon, and amorphous carbon.

17. The negative electrode active material of claim 12, further comprising an element selected from the group consisting of vanadium, chromium, manganese, iron, cobalt, nickel, copper, zinc, zirconium, niobium, molybdenum, tungsten, aluminum, gallium, tin, antimony, bismuth, and a combination thereof.

18. The negative electrode active material of claim 12 wherein the Nb-doped TiO₂(B) has a particle size in the range of 1 nm to 1000 nm.

19. The negative electrode active material of claim 12 wherein the Nb-doped TiO₂(B) includes nanoparticles, nanoplates, or both.

20. The negative electrode active material of claim 12 wherein the Nb-doped TiO₂(B) has a thin layer of inorganic coating.

21. The negative electrode active material of claim 20 wherein the inorganic coating is a carbonaceous coating.

22. A method comprising the steps of:
combining at least one titanium compound and at least one niobium compound in ethylene glycol to form a precursor solution;
adding water into the precursor solution to induce hydrolysis and condensation reactions, thereby forming a reaction solution;
heating the reaction solution to form crystallized particles;
collecting the particles from the dispersion;
drying the collected particles; and
applying a thermal treatment at a temperature >350° C. to the dried particles to obtain Nb-doped TiO₂(B).

23. The method of claim 22 further comprising the step of adding solid particles into the precursor solution.

24. The method of claim 23 wherein the solid particles includes a carbonaceous material.

25. The method of claim 24 wherein the carbonaceous material is selected from activated carbon, graphite, hard carbon, soft carbon, amorphous carbon coated graphite, amorphous carbon coated hard carbon, carbon black, carbon nanofibers, carbon nanotubes, graphene, carbon nanoparticles, carbon onion, crystalline carbon, carbon nanocrystals, semi-crystalline carbon, and amorphous carbon.

26. The method of claim 22 further comprising the step of adding aqueous ammonia into the reaction solution.

27. The method of claim 22 wherein the formed Nb-doped TiO₂(B) particles are crystallized particles having a TiO₂(B) crystal structure with at least one characteristic XRD peaks at about 28.6 degrees or 44.0 degrees (2θ) when measured using CuKα radiation.

28. The method of claim 22 wherein the Nb-doped TiO₂(B) particles comprise nanoparticles, nanoplates, or both.

29. The method of claim 22 wherein a molar ratio of Nb/Ti in the Nb-doped TiO₂(B) particles is ranging from about 1/19 to about 1/1.

30. The method of claim 22 wherein the titanium compound is selected from the group consisting of titanium chloride, titanium ethoxide, titanium isopropoxide, titanium butoxide, titanium acetylacetonate, titanium bis(acetylacetonate)dichloride, titanium glycolate, and a combination thereof.

31. The method of claim 22 wherein the niobium compound is selected from the group consisting of niobium chloride, niobium ethoxide, niobium isopropoxide, and niobium butoxide, niobium acetylacetonate, niobium bis(acetylacetonate)dichloride, niobium glycolate, and a combination thereof.

32. The method of claim 22 wherein the reaction solution is heated at a temperature ranging from about 100° C. to about 200° C.

33. The method of claim 22 wherein the reaction solution is heated at a temperature ranging from about 110° C. to about 185° C.

34. The method of claim 22 wherein the step of the collecting the particles comprises the step of filtering of the dispersion.

35. The method of claim 22 wherein in the thermal treatment step the dried particles are heated at a temperature >350° C.

36. The method of claim 22 wherein in the thermal treatment step the dried particles are heated at a temperature ranging from 450° C. to 650° C.

37. The method of claim 22 wherein the Nb-doped TiO₂(B) particles have particle sizes in the range of 1 nm to 1000 nm.
